(19) United States
(12) Patent Application Publication
(10) Pub. No.: US 2023/0351395 A1
(43) Pub. Date: Nov. 2, 2023

(54) SYSTEM AND METHOD FOR ASSESSING A RISK SCORE FOR A NON-FUNGIBLE TOKEN TRANSACTED ON A BLOCKCHAIN

(71) Applicant: Mastercard International Incorporated, PURCHASE, NY (US)

(72) Inventors: Jonathan Anastasia, Larchmont, NY (US); Himanshu Atre, St. Louis, MO (US)

(21) Appl. No.: 18/308,917

(22) Filed: Apr. 28, 2023

Related U.S. Application Data
(60) Provisional application No. 63/336,993, filed on Apr. 29, 2022.

(51) Int. Cl. G06Q 20/40; G06Q 20/06; G06F 21/64

(52) U.S. Cl. CPC G06Q 20/4016; G06Q 20/065; G06F 21/64

(57) ABSTRACT

A system for assessment of a risk score for a non-fungible token transacted on a blockchain wherein the system is configured to generate a provenance score based on the derived ownership history of the specific non-fungible token, generate a smart contract score based on the retrieved smart contract code for the specific non-fungible token, generate a permanence score based on the retrieved smart contract code for the specific non-fungible token, and generate a comprehensive risk score for the specific non-fungible token based on the generated provenance score, smart contract score, and permanence score for the specific non-fungible token.

### CROSS REFERENCE TO RELATED APPLICATIONS

This application claims the benefit of U.S. provisional application No. 63/336,993 filed on Apr. 29, 2022, which is incorporated by reference herein.

### FIELD

This application relates to a system and method for assessing a risk score for a non-fungible token transacted on a blockchain.

### BACKGROUND

A blockchain is a peer-to-peer electronic ledger implemented as a distributed database shared among computer network nodes. The electronic ledger comprises a series of data blocks, each capable of storing a certain amount of information. Once a block is filled, it is closed and linked to a previously filled block, thereby forming a chain of data known as a blockchain.

The information stored in each of the blocks may include a transaction. A transaction is a data structure that encodes the transfer of control of a digital asset between participants on the computer network implementing the electronic ledger and includes at least one input and at least one output. Each transaction also includes scripts embedded within its inputs and outputs that specify how and who may access the transaction's outputs.

The information stored in each block also includes a previous block's hash, the hashes chaining the blocks together to create a permanent and unalterable record of all transactions written to the blockchain since its inception.

For a transaction to be written to the blockchain, it must be “validated.” The nodes on the network perform the work that ensures that each transaction that is eventually written to the blockchain is valid.

The blockchain may be used to implement “smart contracts” which are computer programs designed to automate the execution of a machine-readable contract or agreement. A smart contract is a machine-executable program that comprises rules that process inputs and perform actions dependent on those inputs. These actions may include the transfer of property rights or assets. These assets may consist of real property, personal property, tangible and intangible property, digital assets such as software, or other types of assets.

Assets are represented and transferred on a blockchain with “tokens.” A token serves as an identifier that allows a real-world asset to be referenced from the blockchain. A fungible token represents a fungible asset, while a non-fungible token represents a non-fungible asset.

Each fungible token is identical to other fungible tokens of the same type and is divisible into smaller amounts. As such, a fraction of a fungible token may be transferred between users on the blockchain. In contrast, each non-fungible token is unique in that it differs from other tokens of the same class and cannot be divided. As such, the elementary unit of the non-fungible token is the token itself.

Accordingly, non-fungible tokens may be considered tokenized versions of digital or real-world assets. And within a blockchain network, they function as verifiable proof of authenticity and ownership of an asset. It follows that non-fungible tokens are not interchangeable and introduce scarcity into a digital world. Identifying information is embedded in the non-fungible token's smart contract to support its uniqueness. This uniqueness makes them ideal for recording and storing the ownership of digital items like collectibles, games, and art.

However, there are risks associated with using non-fungible tokens. Such risks may include money laundering and smart contract risks. What is needed is a system and method that is configured to provide insight into the various risks associated with non-fungible tokens and their underlying assets.

### BRIEF DESCRIPTION OF THE DRAWINGS

The drawings described below are for illustrative purposes only and are not necessarily drawn to scale. The drawings are not intended to limit the scope of the invention in any way. Wherever possible, the same or like reference numbers are used throughout the drawings to refer to the same or like parts.

FIG. 1 is a block diagram of an example embodiment of a system 100 for assessing a comprehensive risk score for a non-fungible token transacted on a blockchain.

FIG. 2 is a block diagram of an example embodiment of a distributed blockchain system 200 that implements a computer-implemented ledger.

FIG. 3 is a flow diagram of an example embodiment of a computer-implemented method 300 for assessing a risk score for a non-fungible token transacted on a blockchain.

FIG. 4 is a flow diagram of an example embodiment of a computer-implemented method 400 for assessing a provenance score for a non-fungible token transacted on a blockchain.

FIG. 5 is a flow diagram of an example embodiment of a computer-implemented method 500 for assessing a smart contract score for a non-fungible token transacted on a blockchain.

FIG. 6 is a flow diagram of an example embodiment of a computer-implemented method 600 for calculating a risk score for a non-fungible token transacted on a blockchain.

### DETAILED DESCRIPTION

This application relates to a system and method for assessing a risk score for a non-fungible token transacted on a blockchain.

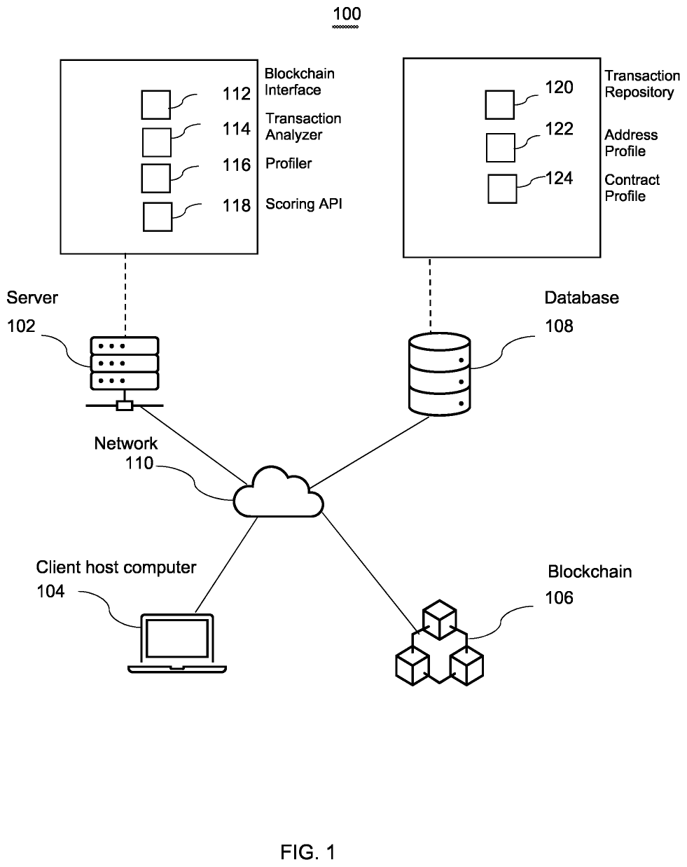

FIG. 1 is a block diagram of an example embodiment of a system 100 for assessing a risk score for a non-fungible token transacted on a blockchain. The system 100 may include a server 102, a client host computer 104, a blockchain 106, a network-based storage or database 108, and a network 110.

The network 110 may allow the server 102, the client host computer 104, and the blockchain 106 to interact over a communications network. The network 110 may be a local area network (LAN), a wide area network (WAN), or the Internet using one or more appropriate network protocols and web services.

The server 102 may be a processor-based computing system capable of executing instructions that specify actions to provide web-based activities and implement an expert or artificial intelligence model. The processor-based computing system may comprise a single or a collection of computing machines. A collection of computing machines may individually or jointly execute sets of instructions that define the web-based services and the expert or artificial intelligence system.

In an exemplary embodiment, the server 102 may implement a blockchain interface 112, a transaction analyzer 114, a profiler 116, and a scoring Application Program Interface (API) 118.

The blockchain interface 112 may scan every block written to the blockchain 106, extract transaction data, and add extracted transaction data to the transaction depository stored on the database 108. The blockchain interface 112 may also interpret the application binary interface of a smart contract.

The transaction analyzer 114 may investigate and extract relevant data from transactions executed on the blockchain 106.

The profiler 116 may create addresses and contract profiles on the database 108 for each user's wallet address and contract address based on data from the transaction analyzer 114.

The scoring API 118 may be an interface that users use to query the system 100 for a comprehensive risk score of a smart contract on the blockchain 108.

The client host computer 104 may be any processor-based device that allows users to communicate over the network 110 with the server 102 and the blockchain 106. The client host computer 104 may provide the users with standard inputs and outputs, including keyboard, display, and voice functionality. The client host computer 104 may be any processor-based device, including a desktop computer, a laptop computer, a smartphone, or any other similar type of device known to a person of ordinary skill in the art.

The blockchain 106 may be any system implementing a distributed ledger on which smart contracts for non-fungible tokens are transacted, stored, and maintained.

The network-based storage 108 may be any network-enabled third-party storage that allows for the storage of and access to underlying assets that a non-fungible token may reference over the network 110. The network-based storage 108 may have a centralized or decentralized configuration and implement various types of file systems.

In an exemplary embodiment, the network-based storage 108 may include a transaction repository 120, an address profile 122, and a contract profile 124.

The transaction repository 120 may include a record of each transaction related to each smart contract implemented on the blockchain 106.

The address profile 122 may comprise models for each wallet address involved in a transaction on the blockchain 106. Each model may comprise attributes of a wallet address, including transaction volume, cumulative value, and tags that define the behavior of the wallet address.

The contract profile 124 may comprise models for each smart contract executed in the blockchain 106. Each model may comprise attributes of a smart contract, including token supply, total tokens in circulation, lifetime transaction volume, rolling weekly/daily transaction volumes, average transaction size, and smart contract event history.

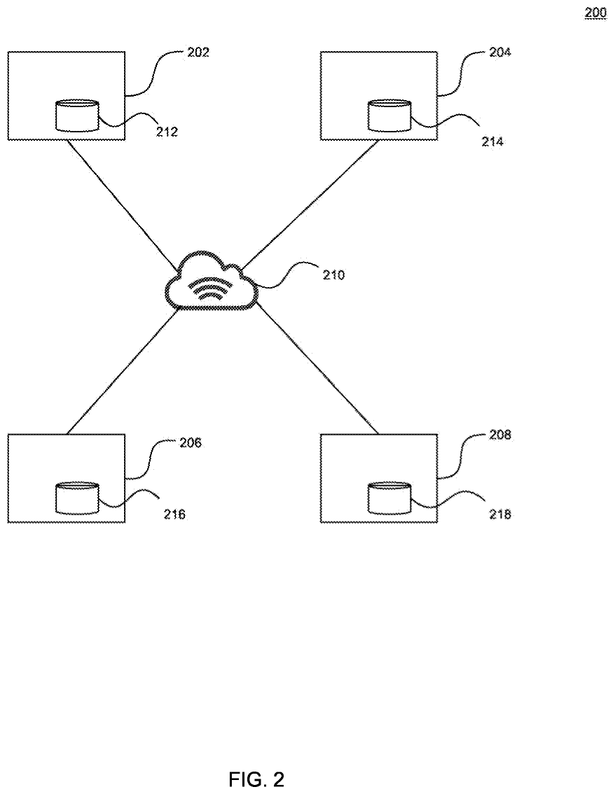

FIG. 2 is a block diagram of an example embodiment of a distributed blockchain system 200 that implements a computer-implemented ledger.

The blockchain system 200 is a distributed ledger peer-to-peer network that enables trustless processing and recording of transactions, including the movement and recording of tokens. The blockchain records transactions in the form of a cryptographically secured backlinked list of blocks. Each block may include a non-fungible token record containing metadata about the non-fungible token. The metadata may include a URL linking to the non-fungible token asset's image file; the percentage of royalties to the creator for each resale; the smart contract address on the blockchain; whether the underlying asset can be resold; the non-fungible token creator's address on the blockchain; the edition number of the underlying asset; the title of the underlying asset; a link to the non-fungible token sale listing; the downloadable file of the underlying asset; the name of the underlying asset; and the total number of editions of the underlying asset.

The blockchain system 200 comprises multiple computing devices configured as nodes 202, 204, 206, and 208 interconnected over a blockchain network 210.

Each node 202, 204, 206, and 208 locally stores and maintains an identical copy 212, 214, 216, and 218 of the blockchain ledger. The nodes 202, 204, 206, and 208 exchange messages within the blockchain network 210 to update and synchronize the ledger stored and maintained by each of the nodes 202, 204, 206, and 208.

The nodes 202, 204, 206, and 208 may also execute decentralized applications (e.g., smart contracts) for processing the messages, including exchanging a token within the blockchain network 210. The messages may include information on a confirmed transfer of a token and a blockchain public key for each party participating in the transfer.

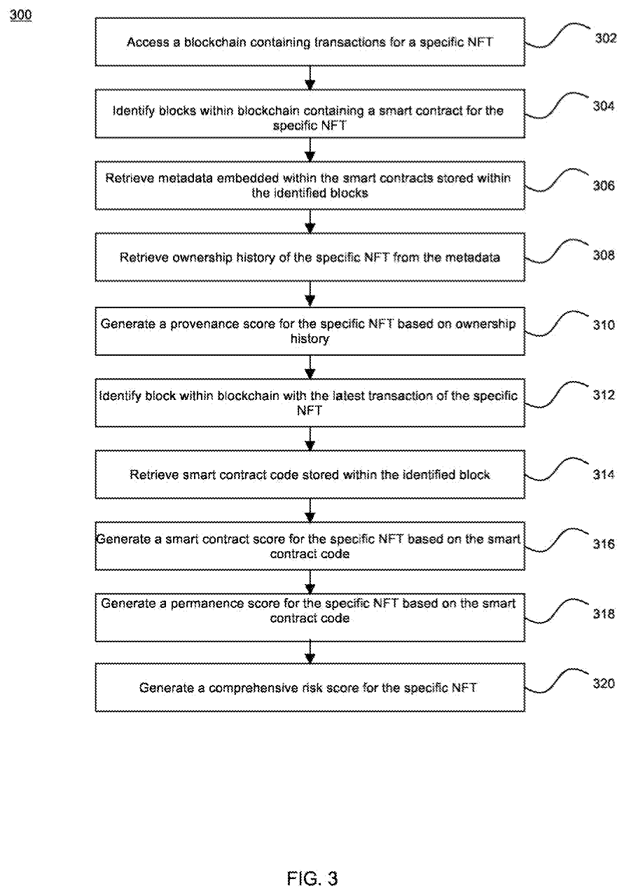

FIG. 3 is a flow diagram of an example embodiment of a computer-implemented method 300 for assessing a comprehensive risk score for a non-fungible token transacted on a blockchain. The computer-implemented method 300 begins in step 302, with the server 102 accessing a blockchain 106 containing transactions for a specific non-fungible token over the network 110.

Once accessed, the server 102, in step 304, scans the blockchain 106 to identify all blocks within that blockchain 106 containing a smart contract for the specific non-fungible token.

The blockchain 106 may be scanned using any block explorer known to a person of ordinary skill in the art for a particular blockchain type, for example, Etherscan for the Ethereum blockchain.

In one embodiment, the relevant blocks are identified based on a real-time scan of the blockchain 106 containing a smart contract for the specific non-fungible token.

In another embodiment, the blockchain 106 is scanned regularly to identify the relevant blocks for the specific non-fungible token. Once identified, the information in the relevant blocks may be stored on the database 108 and then regularly updated as needed based on subsequent scans of the blockchain 106. In this embodiment, the database 108 may store information from the relevant blocks of multiple non-fungible tokens. The data stored on the database 108 may be indexed to retrieve stored information of a specific non-fungible token previously scanned for on the blockchain 106.

Once the blocks have been identified, the server 102, in step 306, retrieves the metadata embedded within the smart contracts stored within each of the identified blocks.

Once the metadata has been retrieved, the server 102, in step 308, retrieves the ownership history of the specific non-fungible token from the retrieved metadata.

The server 102 next, in step 310, generates a provenance score for the specific non-fungible token based on an analysis of the retrieved ownership history. The generated provenance score reflects any ownership-related issues identified by the server 102 based on its analysis of the non-fungible token's ownership history.

Ownership issues may be determined based on a plurality of factors. A factor that may contribute to lowering the provenance score is if the address that deployed the smart contract is identified as high risk for being either related to a sanctioned account or previously identified as a malicious entity.

Another factor that may contribute to lowering the provenance score is the age of the smart contract since it was first deployed on the blockchain. A smart contract that was only recently deployed may pose more of a risk than others that may have a longer history on the blockchain.

Another factor that may contribute to lowering the provenance score is the address that deployed the smart contract on the blockchain having no previous deployments on that same blockchain.

A factor that may raise the provenance score is the address that deployed the smart contract on the blockchain having a name service that resolves to that same address.

The server 102 next, in step 312, identifies that block within the blockchain 106 in which the latest transaction of the specific non-fungible token is stored.

Once the latest block has been identified, the server 102, in step 314, retrieves the smart contract code stored within the identified block.

As an example, the retrieved smart contract code may be bytecode which is then decompiled into a human-readable programming language.

The server 102 next, in step 316, generates a smart contract score based on its analysis of the retrieved smart contract code for the specific non-fungible token.

The generated smart contract score reflects any code-related issues identified by the server 102 based on its analysis of the most current smart contract code for the specific non-fungible token.

The server 102 next, in step 318, generates a permanence score for the specific non-fungible token based on further analysis of the current smart contract code.

The generated permanence score reflects any asset-related issues identified by the server 102 based upon its analysis of the current smart contract code and, more specifically, how the smart contract references the underlying asset of the specific non-fungible token. How the smart contract references the underlying asset may affect the degree to which the underlying asset may be subject to modification or actual deletion. Specifically, what is stored on a blockchain is permanent and immutable. What is stored off the blockchain can potentially disappear, leaving the non-fungible asset with a broken reference that can impact its value.

In an exemplary embodiment, the permanence score may range from zero (0) to one hundred (100), with zero representing a low permanence risk and 100 representing a high permanence risk. A low permanence risk may reflect a scenario in which the metadata and the underlying asset are stored on the same blockchain. A high permanence risk may reflect a scenario where the metadata is stored on the blockchain while the underlying asset is stored on an external centralized server.

A range of medium permanence risk scores may fall between the defined low and high permanence risks, with scores ranging between one (1) and ninety-nine (99).

A first medium permanence risk may reflect a scenario where the metadata and the underlying asset are stored on different blockchains. A second medium permanence risk may reflect a scenario where the metadata is stored on the blockchain while the underlying asset is stored on decentralized storage. Lastly, a third medium permanence risk may reflect a scenario where metadata is stored on the blockchain, and the underlying asset is stored on network storage implementing a distributed file system.

In another exemplary embodiment, the permanence score may be assigned according to predefined scenarios describing various methods of storing the underlying asset.

As an example, the predefined scenarios may include on the blockchain; directly pointing to decentralized storage with pinning; directly pointing to decentralized storage without pinning; indirectly pointing to decentralized storage with pinning; indirectly pointing to decentralized storage without pinning; centralized storage. Each of these scenarios may be assigned a numerical value that reflects its permanence risks, namely, storage on the blockchain may be assigned a numerical value of one (1) as the lowest permanence risk, and centralized storage may be assigned a numerical value of six (6) as the highest permanence risk. According to their respective permanence risk, the remaining scenarios are assigned numerical values between one (1) and six (6).

Lastly, the server 102, step 320, generates a comprehensive risk score for the specific non-fungible token. The generated comprehensive risk score indicates how risky the smart contract for the specific non-fungible token might be. The comprehensive score reflects a combination of the generated provenance score, smart contract score, and permanence score for the specific non-fungible token.

In an embodiment, the comprehensive risk score may be a weighted risk score of all the individual risk scores, including the providence score, the smart contract score, and the permanence score. Each of the individual risk scores may be assigned a weight based on which of the individual risks is more important to a consumer within the comprehensive risk score.

In an exemplary embodiment, the comprehensive risk score may be defined as

$$\frac{{\sum }_{i = 1}^{n} w i X i}{{\sum }_{i = 1}^{n} w i}$$

where:

n=number of individual risk scores;

wᵢ=weight applied to individual risk scores; and

Xᵢ=individual risk score.

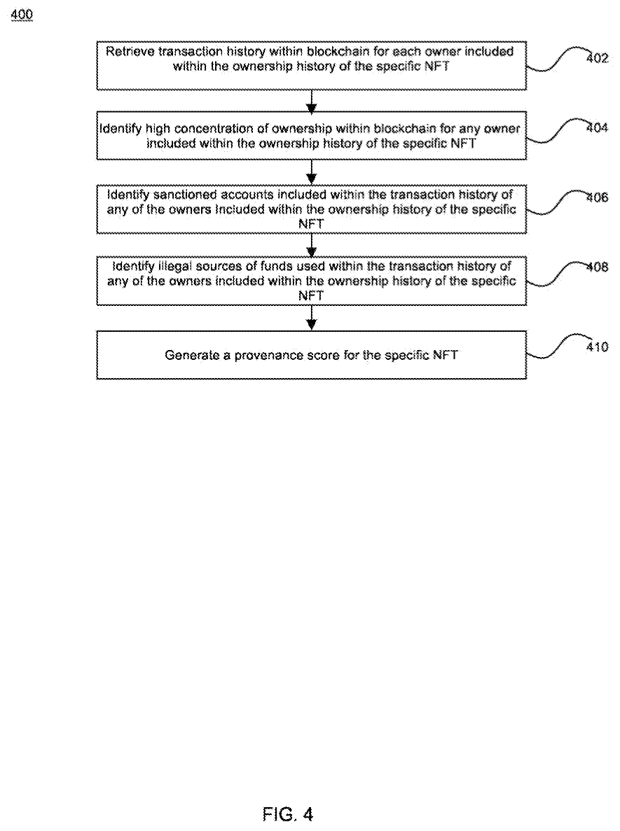

FIG. 4 is a flow diagram of an example embodiment of a computer-implemented method 400 for assessing a provenance score for a non-fungible token transacted on a blockchain 106. The computer-implemented method 400 begins, in step 402, with the server 102 retrieving the transaction history stored within the blockchain 106 for each owner included within the ownership history of the specific non-fungible token.

The server 102 next, in step 404, identifies any high concentration of ownership within the blockchain 106 for any owner included in the ownership history of the specific non-fungible token based on the retrieved transaction histories.

As an example, for smart contracts that follow the ERC-721 standard, ownership concentration may be determined by obtaining the token supply using the tokenURI( ) function, using the ownerOf( ) function to identify the owner wallet address of each token and to determine the number of unique wallet addresses, and calculating the percentage ownership by dividing the number of unique wallet addresses by the token supply. The lower the percentage calculated, the higher the risk of ownership concentration.

The server 102 next, in step 406, identifies any sanctioned accounts included within the transaction history of any of the owners included within the ownership history of the specific non-fungible token.

As an example, a wallet may be identified as sanctioned when it appears on a government sanctioned list such as the Specially Designated Nationals List run by the U.S. Department of the Treasury.

As another example, a wallet may be identified as sanctioned when there is historical on-chain interaction between the wallet and an entity on a sanctioned list.

The server 102 next, in step 408, identifies any illegal sources of funds used within the transaction history of any of the owners included within the ownership history of the specific non-fungible token. Any attempts found to layer or hide stolen cryptocurrencies may be identified and tagged.

As an example, an illegal source of funds may be determined by tracking the trail of transactions on the blockchain from known hacks and thieves.

Lastly, the server 102, in step 410, generates a provenance score for the specific non-fungible token. The provenance score reflects any ownership-related risks associated with the specific non-fungible token based on an analysis of its ownership history.

In an exemplary embodiment, a numeral digit may be assigned to the provenance risk to reflect the risk associated with a non-fungible token's ownership history. As an example, a numeral digit within the range of zero (0) to one hundred (100) may be assigned, zero (0) reflecting a lack of risk and one hundred (100) reflecting a high degree of risk.

In another exemplary embodiment, the analysis of the ownership history may be performed using a rule-based expert system or an artificial intelligence model implemented on the server 102.

The expert system or artificial intelligence model may be provided and trained using a plurality of parameters relating to the ownership history of the non-fungible token.

For example, the parameters may include the current balance of the wallet used to purchase the non-fungible token. This balance may be compared to other wallet balances and be tagged based on this comparison.

Another parameter is the timing and frequency of transactions of the wallet used to purchase the non-fungible token.

Another parameter is the average transaction volume of the wallet used to purchase the non-fungible token.

Another parameter is the average time between buying and selling the same non-fungible token for the wallet used to purchase the non-fungible token.

Another parameter is the inclusion of the wallet used to purchase the non-fungible token on a list of known widespread scams, hacks, or any other security event. The list of known widespread scams, hacks, or any other security event is regularly maintained and updated to accurately reflect current transactions on a plurality of blockchains.

Another parameter is the interaction of the wallet used to purchase the non-fungible token with sanctioned accounts. The interaction may include the wallet itself having been sanctioned or the wallet having traded regularly with other sanctioned accounts.

Lastly, another parameter is the verification status from the marketplaces of the wallet used to purchase the non-fungible token.

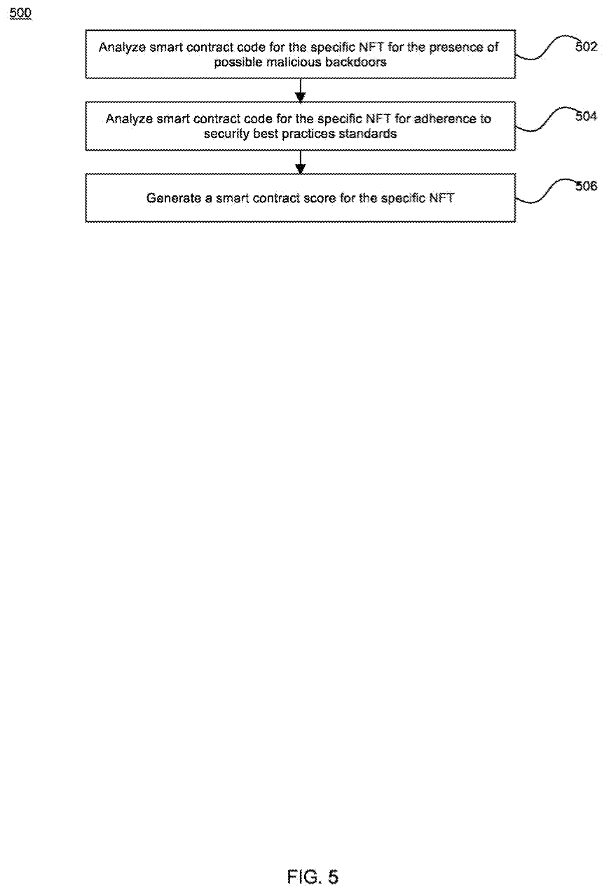

FIG. 5 is a flow diagram of an example embodiment of a computer-implemented method 500 for assessing a smart contract score for a non-fungible token transacted on a blockchain 106. The computer-implemented method 500 begins, in step 502, with the server 102 analyzing the smart contract code for the specific non-fungible token to identify any possible malicious backdoor-type of risks embedded within the code.

Malicious backdoor-type of risks may be identified by analyzing the decompiled bytecode of the smart contract for certain behavior. As an example, this certain behavior may include allowing the arbitrary transfer of tokens from the owner's wallet to another address.

As another example, this certain behavior may include allowing the owner of the smart contract to prevent the transfer of tokens by a token owner, thereby effectively locking the token owner out of access to the assets.

As another example, this certain behavior may include allowing the owner of a smart contract to blacklist some addresses regarding the transfers of tokens, thereby reducing the value of the tokens.

As another example, this certain behavior may include allowing the owner of a smart contract to issue an infinite number of tokens, thereby diluting the value of existing tokens.

As another example, this certain behavior may include allowing a smart contract to call out to other smart contracts whose bytecode is not accessible.

The server 102 next, in step 504, analyzes the smart contract code for the specific non-fungible token to confirm adherence to a defined standard for non-fungible token contracts.

In an exemplary embodiment, the smart contract code is analyzed for conformity with a non-fungible token standard. Among other requirements, this standard requires each smart contract to have a contract address and a token ID pair that are globally unique and permanent and to implement a defined API.

Lastly, the server 102, in step 506, generates a smart contract score for the specific non-fungible token. The smart contract score reflects the code-related risk associated with the specific non-fungible token based on an analysis of its smart contract code.

An exemplary embodiment may assign a numeral digit to the non-fungible token to reflect the risk associated with that token's smart contract code. As an example, a numerical number within the range of zero (0) to one hundred (100) may be assigned, zero (0) reflecting a lack of risk and one hundred (100) reflecting a high degree of risk.

In another exemplary embodiment, the analysis of the smart contract code may be performed using a rule-based expert system or an artificial intelligence model implemented on the server 102.

The expert system or artificial intelligence model may be provided and trained using a plurality of parameters relating to the ownership history of the non-fungible token.

For example, the parameters may include the amount of fungible currency currently held within the smart contract used to purchase the non-fungible token.

Another parameter is the smart contract's age and frequency of deployment used to purchase the non-fungible token.

Another parameter is the average sale price of transactions over a defined period by the smart contract used to purchase the non-fungible token.

Another parameter is the frequency of transactions by the smart contract used to purchase the non-fungible token.

Another parameter is whether the smart contract code used to purchase the non-fungible token is open source.

Lastly, another parameter is whether the smart contract code used to purchase the non-fungible token is verified by a third-party organization, such as Etherscan.

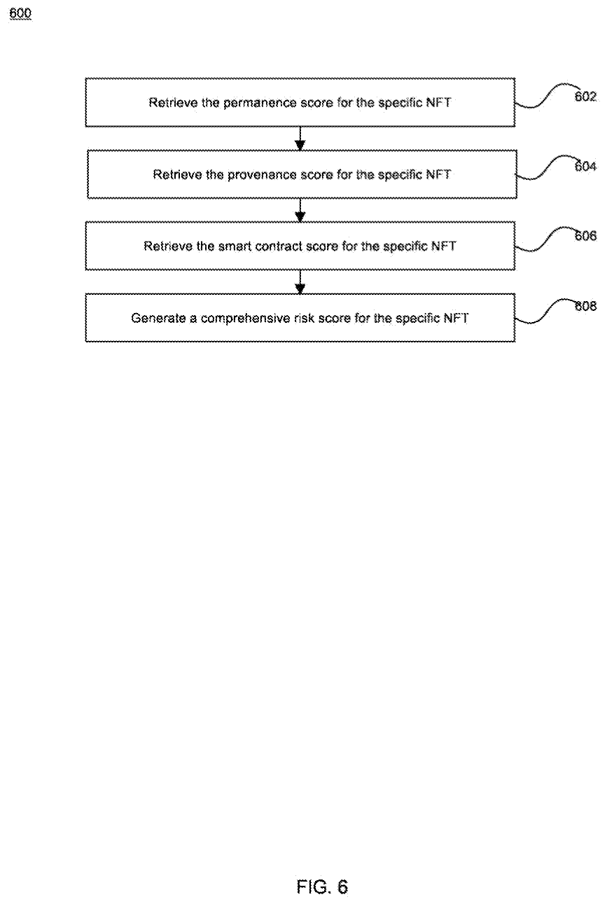

FIG. 6 is a flow diagram of an example embodiment of a computer-implemented method 600 for calculating a risk score for a non-fungible token transacted on a blockchain 106. The computer-implemented method 600 begins, in step 602, with the server 102 retrieving the permanence score for the specific non-fungible token.

The server 102 next, in step 604, retrieves the provenance score for the specific non-fungible token.

The server 102 next, in step 606, retrieves the smart contract score for the specific non-fungible token.

Lastly, the server 102, in step 608, generates a comprehensive risk score for the specific non-fungible token based on the retrieved permanence, provenance, and smart contract scores.

In an exemplary embodiment, a numeral digit may be assigned to the provenance risk to reflect the risk associated with a non-fungible token's ownership history. As an example, a numeral digit within the range of zero (0) to one hundred (100) may be assigned, zero (0) reflecting a lack of risk and one hundred (100) reflecting a high degree of risk.

In another exemplary embodiment, the analysis of the ownership history may be performed using a rule-based expert system or an artificial intelligence model implemented on the server 102.

This disclosure is not intended to limit the invention to the particular assemblies and/or methods disclosed but rather to cover all modifications, equivalents, and alternatives falling within the scope of the claims.

What is claimed is:

1. A system for assessment of a risk score for a non-fungible token transacted on a blockchain comprising:
a blockchain capable of implementing smart contracts for the creation, storing, and transaction of non-fungible tokens;
a processor-based server in electronic communications with the blockchain;
a database in electronic communications with a processor-based server capable of storing and retrieving data;
the processor-based server configured to:
receive a request for assessment of a specific non-fungible token on the blockchain;
scan the blockchain to identify blocks within the blockchain containing a smart contract for the specific non-fungible token;
retrieve metadata embedded within the identified blocks containing a smart contract for the specific non-fungible token;
derive an ownership history of the specific no-fungible token from the retrieved metadata;
scan the blockchain to identify a block within the blockchain containing the last transaction for the specific non-fungible token;
retrieve smart contract code from the identified block containing the last transaction for the specific non-fungible token;
generate a provenance score based on the derived ownership history of the specific non-fungible token;
generate a smart contract score based on the retrieved smart contract code for the specific non-fungible token;
generate a permanence score based on the retrieved smart contract code for the specific non-fungible token; and
generate a comprehensive risk score for the specific non-fungible token based on the generated provenance score, smart contract score, and permanence score for the specific non-fungible token.

2. The system for assessment of claim 1 wherein the processor-based server is further configured to:
input the derived ownership history of the specific non-fungible token into a provenance score model implemented by the processor-based server; and
generate the providence score using the provenance score model.

3. The system for assessment of claim 1 wherein the processor-based server is further configured to:
input the retrieved smart contract code for the specific non-fungible token into a smart contract score model implemented by the processor-based server; and
generate the smart contract score using the smart contract score model.

4. The system for assessment of claim 1 wherein the processor-based server is further configured to:
input the retrieved smart contract code for the specific non-fungible token into a permanence score model implemented by the processor-based server; and
generate the permanence score using the permanence score model.

5. The system for assessment of claim 1 wherein the processor-based server is further configured to:
input the generated providence score, the smart contract score, and the permanence score into a comprehensive risk score model implemented by the processor-based server; and
generate the comprehensive risk score using the comprehensive risk score model.

6. The system for assessment of claim 1 wherein the provenance score is reflective of the ownership history of the specific non-fungible token.

7. The system for assessment of claim 1 wherein the permanence score is reflective of how the retrieved smart contract code references the underlying asset of the specific non-fungible token.

8. The system for assessment of claim 1 wherein the smart contract score is reflective of code-related risk associated with the specific non-fungible token.
